(19) United States
(12) Patent Application Publication
(10) Pub. No.: US 2021/0111561 A1
(43) Pub. Date: Apr. 15, 2021

(54) SYSTEMS AND METHODS FOR REGULATING VOLTAGE ALONG A DISTRIBUTION BUS

(71) Applicant: Schweitzer Engineering Laboratories, Inc., Pullman, WA (US)

(72) Inventor: Jeremy William Blair, Jackson, MS (US)

(73) Assignee: Schweitzer Engineering Laboratories, Inc., Pullman, WA (US)

(21) Appl. No.: 16/736,368

(22) Filed: Jan. 7, 2020

Related U.S. Application Data
(60) Provisional application No. 62/913,988, filed on Oct. 11, 2019.

(51) Int. Cl. H02J 3/18; H02J 13/00; H02J 50/00

(52) U.S. Cl. CPC H02J 3/1878; G05B 2219/2639; H02J 50/001; H02J 13/00002

(57) ABSTRACT

A system may include a transformer that converts a first voltage to a second voltage, such that the second voltage is output via a conductor. The system may also include a wireless current sensor that may detect current data associated with current conducting via the conductor. The system may also include a processor that may receive the current data, determine a voltage at a location on the conductor based on the current data and an impedance associated with the conductor, and send a signal to a load tap changer in response to the voltage being different from an expected voltage at the location.

### CROSS REFERENCE TO RELATED APPLICATIONS

This application claims priority from and benefit of U.S. Provisional Application Ser. No. 62/913,988, filed Oct. 11, 2019, entitled “Systems and Methods for Regulating Voltage Along a Distribution Bus,” which is hereby incorporated by reference in its entirety for all purposes.

### BACKGROUND

This disclosure relates to systems and methods to monitor and regulate an output voltage of a power transformer. More particularly, this disclosure relates to monitoring a load served by a power transformer by means of a current transformer in a non-invasive way, and regulating the output voltage of the power transformer based on a current measurement.

Electrical power grid is an interconnected network for delivering electricity from producers to consumers. To transport electrical power efficiently and safely, power transformers are often used to step up or down the voltage at which electricity flows across a conductor. Large power transformers are often built with several current transformers installed on each bushing intended for many different functions such as protection, metering, and monitoring of the power transformer. However, it may be difficult to install a new current transformer on an existing downstream transformer without shutting down electrical power to allow the current transformer to be installed in a safe manner.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of any kind.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In a first embodiment, a system may include a transformer that converts a first voltage to a second voltage, whereby the second voltage is output via a conductor. The system may also include a wireless current sensor that detects current data associated with current conducting via the conductor. The system may further include a processor, which receives the current data, determines a voltage at a location on the conductor based on the current data and an impedance associated with the conductor, and sends a signal to a load tap changer in response to the voltage being different from an expected voltage at the location, whereby the signal causes the load tap changer to change a tap output of the transformer.

In a second embodiment, a method for monitoring and regulating transformer output voltage is provided. The method may include receiving, via a processor, current data from a wireless current sensor coupled to a conductor conducting current output by a transformer. The transformer may convert a first voltage to a second voltage that is output via the conductor. The method may also include determining, via the processor, a voltage at a location on the conductor based on the current data and an impedance associated with the conductor. The method may further include sending, via the processor, a signal to a load tap changer of transformer in response to the voltage being different from an expected voltage at the location, whereby the signal causes the load tap changer to change a tap output of the transformer.

In a third embodiment, a non-transitory computer-readable medium stores computer-executable instructions that when executed by a processor, may cause the processor to receive current data from a wireless current sensor coupled to a conductor conducting current output by a transformer. The transformer may converts a first voltage to a second voltage that is output via the conductor. The instructions, when executed by the processor, may also cause the processor to determine a third voltage at a location on the conductor based on the current data and an impedance associated with the conductor. The instructions, when executed by the processor, may further cause the processor to send a signal to a load tap changer of transformer in response to the third voltage being different from an expected voltage at the location, whereby the signal causes the load tap changer to change a tap output of the transformer.

### BRIEF DESCRIPTION OF THE DRAWINGS

FIG. 1 illustrates a typical electric power system, including power generation, transmission, and distribution, in accordance with an embodiment;

FIG. 2 illustrates a power transformer with current transformers dispersed therein and wireless current sensors dispersed on conductors coupled to the power transformer, in accordance with an embodiment;

FIG. 3 is a schematic diagram of a wireless current sensor (WCS), in accordance with an embodiment; and

FIG. 4 illustrates voltage regulation at a remote location downstream of the distribution grid, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Certain examples commensurate in scope with the originally claimed subject matter are discussed below. These examples are not intended to limit the scope of the disclosure. Indeed, the present disclosure may encompass a variety of forms that may be similar to or different from the examples set forth below.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

Electric power delivery system may generate, transmit, and/or distribute electric energy to loads. The power grid system may include electric generators, power transformers, conductors, circuit breakers, busses, regulators, capacitors, distribution transformers, and loads, etc. The power system may further comprise communication devices that facilitate communication in a network to support the industrial control system. The electric power delivery system may be monitored, controlled, automated, and/or protected using intelligent electronic devices (IEDs).

Power transformers are used in transmission network of higher voltages for step-up and step down applications. Large power transformers (LPTs) are essential components of a power transmission system. A damaged or destroyed power transformer may affect the transmission capacity of a regional electric power system. In particular, the loss of multiple high-voltage LPTs may eventually overwhelm the power system and cause widespread power outages, possibly in more than one region, increasing vulnerability and the potential for cascading failures. A timely replacement of multiple failed LPTs is a challenge, due to the complex and lengthy process involving the order, design, manufacturing, and transportation of LPTs. Therefore, the operational failure of multiple LPTs may result in a long-term service interruption and considerable economic loss.

LPTs represent expensive assets, so their owners/operators are motivated to thoroughly monitor these transformers and respond to alarms and other maintenance indicators. In addition, certain regulations (e.g., voltage regulation) may be applied to transformers to ensure the performance, efficiency, and reliability of the LPT and the electric distribution system. LPTs may include several current transformers installed on each bushing. The current transformer is a type of transformer that is used to reduce or multiply an alternating current (AC). It produces a current in its secondary which is proportional to the current in its primary. Current transformers serve as current-sensing units of the power system. The built-in current transformers on a LPT may be used for many different functions such as protection, metering, and monitoring.

In addition, a power transformer used in distribution substations may include a mechanism (e.g., load tap changer) to regulate output voltage at various points downstream of distribution bus via the power transformer. Indeed, at times, the mechanism may regulate the voltage at a particular location or position of a conductor downstream of the distribution bus to a particular value within a range of voltage values. To regulate the voltage output at various positions on a conductor or distribution bus, the present embodiments described herein may employ a line drop compensation method in which the current flowing from the power transformer is used to calculate the voltage drop at a specific point on the conductor downstream from the power transformer. The current conducting on the conductor may be measured via a current transformer disposed inside the power transformer.

With this in mind, in existing substations that are continuously providing power to consumers, it may be difficult to install a new current transformer for those power transformers that lack a current transformer. As such, these transformers that lack current sensing capabilities may not be able to regulate voltage using the line drop compensation method. Instead, to install a new current sensor within the power transformer or on the bushings of the power transformer, power provided to the transformer may be removed, such that the new current sensor can be safely installed therein. As a result of powering down the power transformer, consumers receiving electricity via the power transformer may experience a power outage. To avoid inconveniencing the consumers with potential power outages, the present embodiments describe a non-invasive method for installing a new current transformer for use with a power transformer or the like.

Keeping the foregoing in mind, a wireless current sensor (WCS) may provide feasible and non-invasive solutions to the issues described above. The WCSs are advantageous compared to conventional current transformers. For instance, no additional conductor is involved to connect the WCSs to the power transformer. In addition, no battery is involved to power the WCSs (as they may draw power from a primary wire through inductance) nor is electrical wiring need to connect the WCSs to a power source. As a result, the WCS may not encounter limitations due to the placement of these device. Unlike conventional current transformers, which may involve electrical wiring and may be located close to an IED, WCSs may not necessarily to be installed near a power source or near the IED to transmit electrical current measurement data to the IED (such as an IED in transformer controller). The WCS may be implemented on an electrical delivery system in order to monitor current data within a power transformer. It may be located at certain distance away from a transformer and may wirelessly send data of current magnitude, phase, and angle to a transformer controller. The transformer controller cabinet may be located on or near a transformer and may contain processing circuitry that receive data from a WCS and analyze the data and control the transformer based on the data that is analyzed and the rated conditions of the transformer. With WCSs, new current sensor installation becomes practical even when there is not space available on the operating power transformer. It may also avoid the need for installing new conductors, thus no rewiring or power shutdown is needed.

The embodiments of the disclosure will be best understood by reference to the drawings, wherein like parts are designated by like numerals throughout. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

In some cases, for the sake of brevity and clarity, well-known features, structures, or operations are not shown or described in detail. Furthermore, the described features, structures, or operations may be combined in any suitable manner in one or more embodiments. It will also be readily understood that the components of the embodiments as generally described and illustrated in the figures herein may be arranged and designed in a wide variety of different configurations.

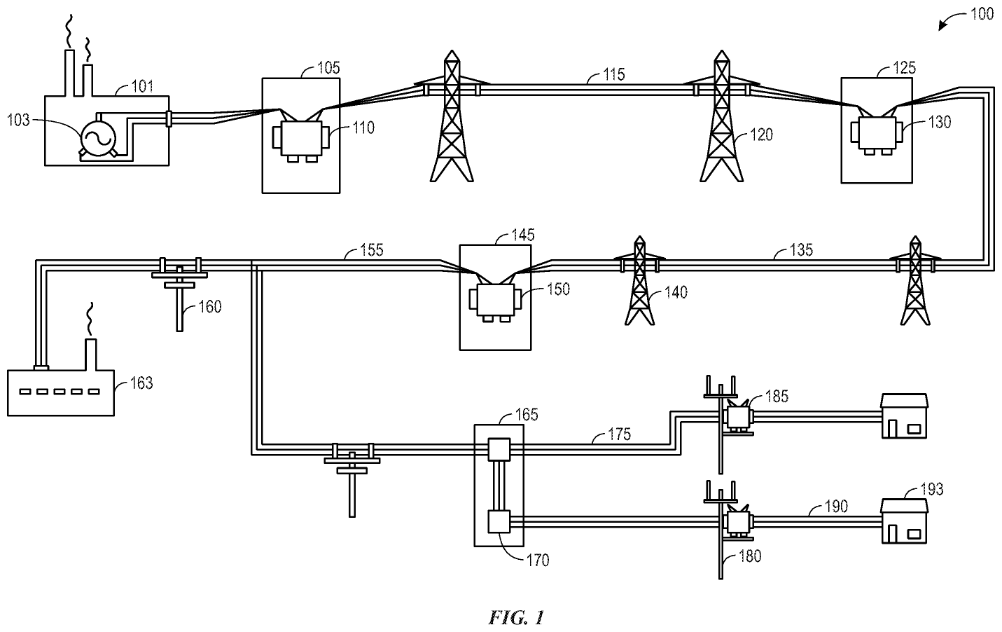

Turning now to the figures, FIG. 1 illustrates a simplified diagram of an embodiment of an electric power delivery system 100. For example, the electric power delivery system 100 may generate, transmit, and/or distribute electric energy to loads. Typically it consists of: generating stations that produce electric power; electrical substations for stepping electrical voltage up for transmission, or down for distribution; high voltage transmission lines that carry power from distant sources to demand-centers; and distribution lines that connect individual customers. Power stations may be located away from heavily-populated areas, for instance near a fuel source or at a river/reservoir dam. The electric power generated is stepped up to a higher voltage at which it connects to an electric power transmission network. The transmission network moves the power long distances until it reaches regional electric power distribution network. On arrival at a substation, the power is stepped down from a transmission level voltage to a distribution-level voltage. As it exits the substation, it enters the local distribution network. Finally, upon arrival at the service location, the power is stepped down again from the distribution voltage to the required service voltage.

As illustrated, the electric power delivery system 100 includes electric power generating station 101 where an electric generator 103 is installed. The electric power delivery system 100 may also include transmission station 105 where a step-up power transformer 110 is installed. The electric power delivery system 100 may also include primary transmission lines 115, towers 120, and a receiving station 125, which may include a step-down power transformer 130. Following the step-down power transformer 130, secondary transmission lines 135 and towers 140 may deliver power to a primary distribution station 145 that may include a power transformer 150. In the same manner as described above, the power transformer 150 may supply power to primary distribution lines 155 that may be physically lifted from the ground using poles 160. Power may then be provided to industrial consumers 163 and a secondary distribution station 165, which may include circuit breakers 170 to control the flow of power in the system. Finally, secondary distribution lines 175 coupled to poles 180 may distribute power to pole-mounted distribution transformers 185, such that local distribution lines 190 may provide power to residential consumers 193. Although not shown, it should be noted that a variety of other types of equipment may also be included in electric power delivery system 100, such as voltage regulators, capacitors, capacitor banks, and suitable other types of equipment useful in power generation, transmission, and/or distribution.

The electricity that power plants (e.g., the electric power generating station 101) generate is delivered to customers over transmission and distribution systems. It is well established that high-voltage, low-current transmission results in lower power line losses. Therefore, higher voltage electricity is more efficient and less expensive for long-distance electricity transmission, while lower voltage electricity is safer for use in homes and businesses.

As can be seen from above, the electric power delivery system 100 may consist of a primary transmission system and a secondary transmission system. The primary transmission system (e.g., including transmission station 105, lines 115 and towers 120) may provide electricity at a high voltage (normally above 100 kV) over long distance from generating station to regional secondary transmission system(s). The step-up power transformer 110 in transmission station 105 may increase voltages (e.g., around 20 kV) to transmission voltages (e.g., above 100 kV such as 230 kV, 500 kV, or even higher). The secondary transmission (e.g., including receiving station 125, lines 135 and towers 140) may provide electricity at medium voltages from transmission system to distribution systems. At receiving station 125, the step-down power transformer 130 may decrease transmission voltages to lower levels (e.g., 34.5 kV, 46 kV, and 69 kV). At this stage, large industrial customers (not illustrated here) may connect directly to this sub-transmission system.

A power distribution system may provide electricity from transmission systems to local customers. It may consist of the primary distribution system and the secondary distribution system, as described above. In one embodiment, the primary distribution system may include primary distribution station 145, lines 155, and poles 160. On arrival at the primary distribution station 145, power is stepped down from a transmission level-voltage to a distribution-level voltage (e.g., 11 kV or 13 kV) by the power transformer 150. As the primary distribution station 145 outputs the electricity, the electricity then conducts through the distribution wiring. At this stage, a medium industrial customer (e.g., such as industrial consumers 163) may connect directly to the distribution wiring. The secondary distribution system may include the secondary distribution station 165, circuit breakers 170, lines 175, and poles 180. In addition, the secondary distribution system may also include pole-mounted distribution transformer 185 and local distribution lines 190. At the secondary distribution station 165, circuit breakers 170 may control the flow of electricity among distribution lines. Finally, upon arrival at the service location, the voltage is stepped down further from the distribution voltage to the service voltages (e.g., 120 V, 240 V, and 480 V) using the pole-mounted distribution transformer 185.

As discussed in preceding sections, power transformers adjust the electric voltage to a suitable level on each segment of the electric power delivery system 100 from the generator to the end user. Power transformers step up voltage at generation for efficient, long-haul transmission of electricity and step the voltage down for distribution to the level used by customers. Power transformers are also used to step the voltage either up or down at various points where there is a change in voltage in the electric power delivery system 100. As such, the power transformers assist the electric power delivery system 100 to efficiently and effectively provide power to various consumers.

The size of a power transformer may be determined by a primary (input) voltage, a secondary (output) voltage, and a load capacity measured in volt-ampere (VA). In addition to the load capacity rating, voltage ratings are often used to describe different classes of power transformers. For example, large power transformers (LPTs) with voltage ratings of 115 kV and above are considered high voltage (HV), and LPTs with voltage ratings of 345 kV and above are considered extra high voltage (EHV). Power transformers can carry a substantial amount of electricity. Therefore, a faulty or damaged transformer can affect the transmission/distribution capacity of a regional electric power grid, possibly leading to extended power outages. By monitoring the transformer operating status using transformer controller, which may consist of various sensors, meters, current transformers, load tap changers, and intelligent electronic devices, regional power system operators may predict when a single LPT in a substation may go offline and may perform some corrective actions to compensate for the expected loss of power.

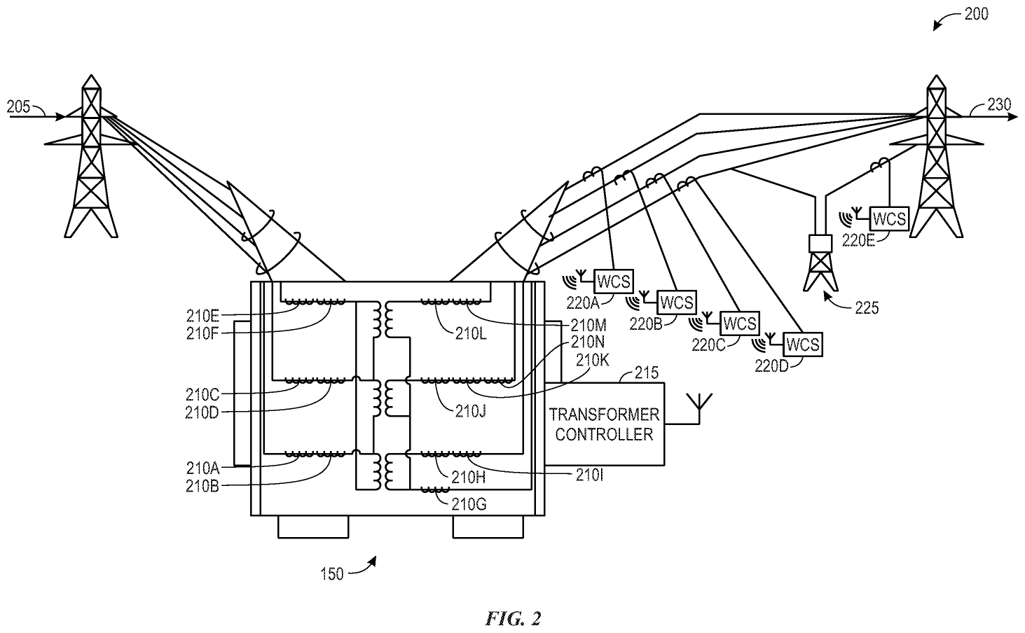

In some embodiments, certain circuit components may acquire data related to the operation of the transformer and may transmit the acquired data to the transformer controller. FIG. 2 is an example schematic diagram 200 with a power transformer 150 that has built-in current transformers and wireless current sensor (WCS) 220 dispersed on conductors outside of the power transformer 150. A three-phase power generator from transmission grid 205 generates current which will travel to a power transformer 150 by means of conducting wires. Power transformer 150 is typically used to step up or step down voltage. In some embodiments, the power transformer may contain current sensors (e.g., current transformers (CTs) 210) dispersed within them. These current transformers 210 may monitor different aspects of a transformer and may contain circuitry to transmit data to update a transformer controller 215 about the status of the power transformer 150. For instance, CTs 210A, 210C, 210E, 210I, 210K, and 210M may be used for the protection of the power transformer 150. These CTs may function as part of a transformer differential relay system and may be sensitive to the occurrence of faults in the region that they are located. These CTs may monitor the occurrence of faults within the regions they occupy. Typical faults that may be detected by these CTs can be internal faults such as an earth fault, a breakdown of insulation in the core of the power transformer 150, an inter-turn fault, and the like.

Another method of protecting the power transformer 150 may include an overcurrent relay system. For example, the CTs 210B, 210D, 210F, and 210G may support the functioning of an overcurrent relays. Overcurrent relays protect the power transformer 150 against faults and short circuits where the current conducting through a respective part of the power transformer 150 exceeds some threshold current. That is, the overcurrent relays may receive a current and open a circuit to stop the flow of current when the current exceeds a threshold associated with the respective overcurrent relay. With this in mind, the CTs that support the overcurrent relay system may detect if the received current exceeds the current rating of the power transformer 150 and open a contact in response to the current exceeding the ampere rating, thereby protecting the power transformer 150 from thermal or electrical damage.

Further, CT 210G is may be connected to a neutral wire or to a grounded wire to provide a fault backup protection mechanism. If the CT 210G senses current above a certain threshold, the CT 210G may send an indication or notification to the transformer controller 215 that a fault is detected. The CT210 may also be a part of a relay system such that, a switch connecting of one or more wires to the power transformer 150 may be opened in response to the current being above the threshold. The CTs 210H, 210J, and 210L may provide a metering for the current flow through each respective conductor. This metering of current flow may be used to calculate an amount of power that a consumer uses, and the calculated amount of power can be used to calculate a power or energy bill for the consumer. The CTs 210H, 210J, and 210L may accurately measure the current flow, since their measurements are used for billing purposes. Further, the CT 210N may be used as an asset-management or a system control CT.

In some embodiments, the CTs disposed on conductors within a power transformer or on the bushings of the power transformer may be used in conjunction with a transformer controller, which comprises a processor and memory device, to monitor a load served by the power transformer and regulate the output voltage of the power transformer based on current measurement. That is, the transformer controller may receive the current measurements from the CTs. In addition, the transformer controller may employ the line drop compensation (LDC) method that may use the measured current and other information (such as known system impedances) to calculate a voltage drop at a remote location downstream of the distribution line with respect to the source of the current (e.g., the voltage drop between the location on a conductor and a tap output of the power transformer). Furthermore, based on an input provided to the transformer controller that indicates a desired voltage at that remote location, the transformer controller may use an actuator, circuit breakers, or a load tap changer to cause the taps connected to the output of the power transformer to be adjusted to compensate the voltage drop. For example, a signal may be sent by the transformer controller to the load tap changer in response to the voltage being different from an expected voltage at the remote location, and the load tap changer may change a tap output of the transformer to compensate the voltage drop. The load tap changer may cause the power transformer to change the tap output by changing a number of turn rations for the transformer. With this in mind, a CT that is intended for use with a transformer controller may not be present on some transformers that are already installed in a substation. Indeed, in these cases, installing such a CT on a power transformer that is already in operation in a substation may be challenging and disruptive since the transformer should be powered down such that the CT can be installed in the power transformer or on the bushings of the power transformer. That is, to install a new CT in the transformer or on the bushings of the transformer, in one embodiment, the following procedure may be undertaken. First, electrical power provided to the transformer may be isolated. Next, an enclosure of the transformer may be opened, the new CT may be installed on an available conductor or bushings of the transformer, and the enclosure of the transformer may be closed after the new CT is installed. Finally, the electrical power may be recoupled to the transformer. This process may cause consumers to lose electric power for a certain amount of time. With this in mind, the present embodiments described herein may include installing a wireless current transformer on a conductor outside of the power transformer 150, such that the wireless current transformer may perform current measurements outside of the power transformer 150. These measurements may be analyzed to give accurate information about certain operating conditions and measurements inside the power transformer 150.

With this in mind and referring to FIG. 2, in some embodiments, wireless current sensors (WCSs) may be connected to conductors coupled to the power transformer 150. In FIG. 2, WCS 220A, 220B, 220C, 220D, and 220E may be current sensors that detect current conducting via a conductor that may be coupled to a respective current sensor. The WCS 220 may include any suitable current sensor, such as a current transformer, that wirelessly transmits information to another communication-enabled component. In one embodiment, the WCS 220 may send current data to the transformer controller 215 that may detail a magnitude, phase, and angle of the current flowing through a respective conductor. As displayed in FIG. 2, a three-phase four wire scheme is implemented on the power grid. In a three-phase power system, the current in any one of the three conductors, which, in some embodiments, are coupled between the transmission grid 205 and a left bushing of the power transformer 150, are expected to be phase-shifted by an angle of 120 degrees relative to the current conducting in each of the other two conductors, while the fourth conductor may be a neutral or ground conductor. The WCS 220 attached or clamped to each of the four conductors may measure a phase, magnitude, and angle of the current flowing through them and send its respectively acquired measurements to the transformer controller 215.

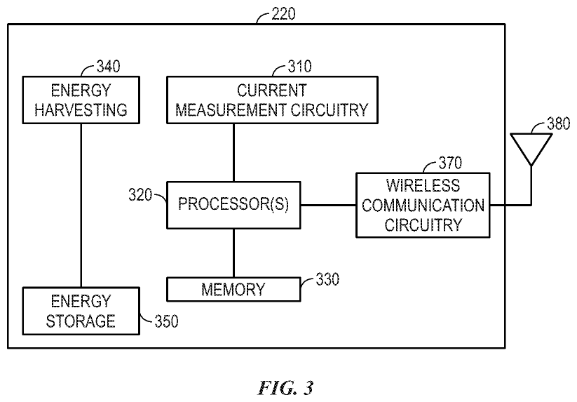

Current data can be useful for monitoring certain conditions of the power transformer 150. By way of example, FIG. 3 is a schematic diagram of circuitry that may be part of the WCS 220. The WCS 220 may include an energy harvesting 340 mechanism to collect power through inductance or some other suitable energy harvesting tool. In one embodiment, an alternating current produces a time-varying magnetic field along with a time-varying electric field. The WCS 220 may include a core that may open and be positioned around a conductor, such that the current traversing the conductor may produce an alternating magnetic field in the core. By way of inductance, the WCS 220 may extract energy from the alternating magnetic field and/or electrical field produced in the core. The WCS 220 may have a winding around the core, such that the current traversing the conductor may induce a current in the winding around the core at some ratio depending upon the amount of turns in the winding. In some embodiments, the energy acquired via the conductor may be used to provide power to the circuit components of the WCS 220. The WCS 220 may store the energy it receives in an energy storage component 350. In some embodiments, the WCS 220 may not include a battery, instead the WCS 220 may temporarily store the energy it receives by inductance from the conductor into the energy storage component 350. The electrical power stored in the energy storage component 350 may be utilized for processor(s) 320 to function and to send a wireless signal to transformer controller 215 via wireless communication circuitry 370 and transmitter 380. Further, WCS 220 may include a memory 330, which contains instructions for the execution of the measurements and calculation that are to be done by the processor(s) 320. The processor(s) 320 may control the execution of the instructions that are stored in the memory 330, and the measurements and calculations that are performed may be sent to the transformer controller 215 via the wireless communication circuitry 370 and transmitter 380.

The current measurement circuitry 310 may receive the alternating current signal conducting via the windings surrounding the core of the WCS 220. As such, the current measurement circuitry 310 may measure a magnitude of the current waveform in the windings. The current waveform may represent the current conducting in the conductor surrounded by the core of the WCS 220. The current measurement circuitry 310 may send the measured current waveform to the processor(s) 320, such that the processor(s) 320 may determine the current conducting within the conductor by scaling the received current waveform by a ratio that corresponds to a number of windings in the winding surrounding the core.

Keeping the foregoing in mind, the processor(s) 320 may operate as thermal monitor by correlating current measurements with temperature measurements in the power transformer 150. As such, the resulting temperature measurements may be analyzed to provide information regarding the operating conditions of the power transformer 150. Also, the processor(s) 320 can also be used in the process of sensing faults in the power transformer 150 and/or in the process of sensing the breakdown of components within the power transformer 150, such as an insulation breakdown, based on the received current measurements from the CTs and the calculated internal temperatures of the power transformer 150. As such, it may be beneficial to continuously monitor the internal properties of the power transformer 150, since a surge of electrical power for a relatively small amount of time (e.g. a few milliseconds), can cause permanent damage to the power transformer 150. Thus, monitoring temperature in the power transformer 150 may assist in protecting the power transformer 150 from incurring damage that may lead to shorter life expectancy for the power transformer 150. That is, one or more component statuses (e.g. winding temperature, oil temperature, etc.) that indicate that the components are operating above some threshold (i.e. above the designed operating temperature for the respective component) may be a precursor to those components incurring permanent damage, which can decrease the life expectancy of the power transformer 150.

As discussed in preceding sections, one function of LPTs in a distribution substation is voltage regulation. Voltage regulation is related to controlling a voltage magnitude output to a load, a conductor, or the like. It may be used in power engineering to describe a percentage voltage difference between no load and full load voltages on distribution lines. In some embodiments, LPTs used in distribution substations may include a load tap changer (LTC) to regulate output voltage within a desired range of values or bandwidth. The LTC may be a mechanism in transformers that allows for variable turn ratios for the transformer to be selected in discrete steps. That is, the LTC may provide electrical connections to a number of access points known as taps along either a primary or secondary winding in the transformer, such that each tap provides a different voltage output. The LTC may boost or buck output voltage (e.g., by +/−10%). In some embodiments, LTC may take command from an LTC controller, which may be part of the transformer controller 215 or any other suitable control system. The LTC controller may receive voltage and current measurements from a voltage or current sensor, analyze the measurements, and instruct the LTC to raise or lower the voltage to ensure a voltage at a particular position on a conductor or remote distribution bus remains within the desired range of values or bandwidth.

To determine a voltage to output via the power transformer 150 to achieve a desired voltage at a particular position on the remote distribution bus, the LTC controller may receive a voltage measurement on the remote distribution bus. One way to achieve this is directly measuring the voltage at the desired remote location and then transmitting the measured voltage to the LTC controller. However, this may involve additional voltage measurement and communication devices positioned across the distribution bus. In some embodiments, current transformers may be deployed anywhere along the distribution line between the LPT and the remote bus location to measure the current conducting via the remote distribution bus (e.g., conductor). Using the measured current, the LTC controller may determine the voltage on remote distribution bus based on the measured current, the output voltage at the LPT, and an impedance between the LPT and the desired point on the remote distribution bus.

In some embodiments, the WCS 220, which may support direct current measurement, may be useful for LPT operations. As described earlier, in an existing substation, a current transformer supporting direct current measurement associated with a specific distribution line may not be present on existing transformers already installed in a substation. As such, a low power consumption device that provides current measurement data for an LTC controller without being invasively installed in a power transformer or on the bushings of the power transformer may be more favorable for field operations. As such, the WCS 220 may provide current data (i.e. magnitude, phase, and angle) to the LTC controller to determine the voltage on the remote distribution bus and for other applications including protection, metering, and monitoring. As shown in FIG. 3, the WCS 220 may include wireless communication circuitry that may send real time data to the LTC controller, the transformer controller 215, or the like to enable the respective controller to control the output of the power transformer 150, such that a desired voltage value is achieved at a desired position on a conductor or the remote distribution bus.

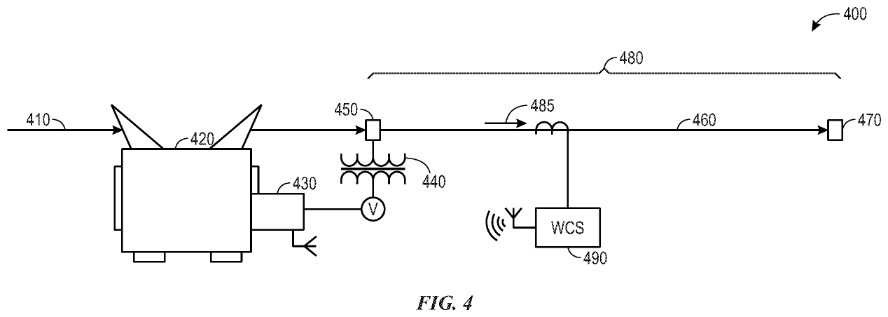

FIG. 4 illustrates schematically a voltage regulation mechanism 400 at a remote location downstream of the distribution grid. For the sake of simplicity, an electrical one-line diagram is used here for illustration purpose instead of a three phase diagram. The electrical current is distributed from transmission grid 410 to a power transformer 420 by means of conductors. The power transformer 420 may be used to step up or step down voltage received from the transmission grid 410. A transformer controller 430 may be attached to the power transformer 420, such that the transformer controller 430 may control protection, metering, and monitoring devices on the power transformer 420. In addition, the transformer controller 430 may host other intelligent electronic devices (IEDs), such as the LTC controller mentioned above. Further, the transformer controller 430 may also include wireless communication devices that may exchange data with other wireless devices such as WCSs.

As mentioned above, to regulate the voltage at a remote location downstream of the distribution line (e.g., at a remote circuit breaker 470), the transformer controller 430 may employ the LDC method that may use the current measured at the remote location and known system impedances to calculate a voltage drop at the remote location with respect to the source of the current. With this in mind, in some embodiments, a WCS 490 may be mounted on the conductor between the transformer bushing and the bus using a hot stick, such that the WCS 490 may measure the current properties of the respective conductor.

With the preceding in mind and referring to FIG. 4, in one embodiment, the transformer controller 430 may employ an LDC method that uses secondary quantities (such as impedance, measured voltage and current) to regulate the voltage at a point on a downstream line remote from the power transformer 420. The voltage at a circuit breaker 450 may be measured via a voltage sensor such as a voltage transformer 440, which may be communicatively connected to the power transformer controller 430. Additionally, current 485 conducting along conductor 460 may be measured by the WCS 490 and transmitted to the transformer controller 430. Based on the impedance between the circuit breaker 450 and the remote circuit breaker 470 connected to the conductor 460, the transformer controller 430 may determine a voltage at the remote circuit breaker 470 based on the voltage measured at the circuit breaker 450 and the impedance between the circuit breaker 450 and the remote circuit breaker 470. For example, if the voltage at the circuit breaker 450 is 125 V, the impedance of the conductor 460 is 50 ohms, and the measured current received from the WCS 490 is 140 mA, the transformer controller 430 may determine the voltage at the remote circuit breaker 470 is 118 V. As such, the 7 V difference between the voltage at the circuit breaker 450 and the remote circuit breaker 470 indicates there is a voltage drop on the conductor 460. Based on an input provided to the transformer controller 430 that indicates a desired voltage at the remote circuit breaker 470, the transformer controller 430 may use an actuator or LTC unit to cause the taps connected to the output of the power transformer 420 to be adjusted to compensate the voltage drop.

The embodiments described herein may be suitable for other applications related to utilizing WCSs to monitor and control transformer operations. In certain applications, a plurality of WCSs may be implemented among multiple three phase transmission/distribution lines to simultaneously acquire current data including magnitudes, phases and angles. The acquired data may provide real time guidance for power transmission and/or distribution system monitoring and controlling.

While specific embodiments and applications of the disclosure have been illustrated and described, it is to be understood that the disclosure is not limited to the precise configurations and components disclosed herein. For example, the systems and methods described herein may be applied to an industrial electric power delivery system or an electric power delivery system implemented in a boat or oil platform that may or may not include long-distance transmission of high-voltage power. Accordingly, many changes may be made to the details of the above-described embodiments without departing from the underlying principles of this disclosure. The scope of the present disclosure should, therefore, be determined only by the following claims.

The embodiments set forth in the present disclosure may be susceptible to various modifications and alternative forms, specific embodiments have been shown by way of example in the drawings and have been described in detail herein. However, it may be understood that the disclosure is not intended to be limited to the particular forms disclosed. The disclosure is to cover all modifications, equivalents, and alternatives falling within the spirit and scope of the disclosure as defined by the following appended claims. In addition, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). For any claims containing elements designated in any other manner, however, it is intended that such elements are not to be interpreted under 35 U.S.C. 112(f).

What is claimed is:

1. A system, comprising:
a transformer configured to convert a first voltage to a second voltage, wherein the second voltage is output via a conductor;
a wireless current sensor configured to detect current data associated with current conducting via the conductor; and
a processor configured to:
receive the current data;
determine a voltage at a location on the conductor based on the current data and an impedance associated with the conductor; and
send a signal to a load tap changer in response to the voltage being different from an expected voltage at the location, wherein the signal is configured to cause the load tap changer to change a tap output of the transformer.

2. The system of claim 1, comprising a voltage sensor configured to detect an additional voltage output by the transformer, wherein the processor is configured to determine the voltage at the location on the conductor based on the current data, the impedance associated with the conductor, and the additional voltage output.

3. The system of claim 1, wherein the wireless current sensor is configured to couple to the conductor while the transformer outputs the second voltage.

4. The system of claim 1, wherein the load tap changer is configured to change the voltage output by the transformer to the conductor.

5. The system of claim 1, wherein the impedance corresponds to a distance between the transformer and the location on the conductor.

6. The system of claim 1, wherein the location on the conductor corresponds to a circuit component.

7. The system of claim 1, wherein the processor is configured to determine the voltage at the location on the conductor based on voltage drop between the tap output and the location on the conductor.

8. The system of claim 7, wherein the processor is configured to determine the voltage at the location on the conductor based on a voltage measurement at the tap output, the current data and the impedance associated with the conductor.

9. The system of claim 1, wherein the signal is received by a load tap changer controller implemented by the processor, wherein the load tap changer controller is configured to cause the load tap changer to change a number of turn ratios for the transformer based on the signal.

10. The system of claim 1, wherein the wireless current sensor includes an energy harvesting mechanism to collect power through inductance.

11. A method for monitoring and regulating transformer output voltage, comprising:
receiving, via a processor, current data from a wireless current sensor coupled to a conductor conducting current output by a transformer, wherein the transformer is configured to convert a first voltage to a second voltage, wherein the second voltage is output via the conductor;
determining, via the processor, a voltage at a location on the conductor based on the current data and an impedance associated with the conductor; and
sending, via the processor, a signal to a load tap changer of transformer in response to the voltage being different from an expected voltage at the location, wherein the signal is configured to cause the load tap changer to change a tap output of the transformer.

12. The method of claim 11, comprising receiving, via the processor, an additional voltage output measured by a voltage sensor associated with the tap output of the transformer.

13. The method of claim 11, determining, via the processor, the impedance associated with the conductor based on a distance between the transformer and the location on the conductor.

14. The method of claim 11, comprising:
determining, via the processor, an output voltage by the transformer to compensate for a voltage drop at the location on the conductor due to the impedance associated with the conductor; and
determining, via the processor, the signal based on the output voltage.

15. The method of claim 11, wherein the signal to the load tap changer contains instructions configured to cause the load tap changer to change a number of turn ratios for the transformer to change the tap output of the transformer.

16. A non-transitory computer-readable medium comprising computer-executable instructions that, when executed by a processor, are configured to cause the processor to:
receive current data from a wireless current sensor coupled to a conductor conducting current output by a transformer, wherein the transformer is configured to convert a first voltage to a second voltage, wherein the second voltage is output via the conductor;
determine a third voltage at a location on the conductor based on the current data and an impedance associated with the conductor; and
send a signal to a load tap changer of transformer in response to the third voltage being different from an expected voltage at the location, wherein the signal is configured to cause the load tap changer to change a tap output of the transformer.

17. The non-transitory computer-readable medium of claim 16, wherein the computer-executable instructions, when executed by the processor, cause the processor to receive a fourth voltage measured by a voltage sensor that corresponds to the tap output of the transformer.

18. The non-transitory computer-readable medium of claim 17, wherein the computer-executable instructions, when executed by the processor, cause the processor to determine a voltage drop at the location on the conductor based on the third voltage at the location on the conductor and the fourth voltage associated with the tap output of the transformer.

19. The non-transitory computer-readable medium of claim 16, wherein the computer-executable instructions, when executed by the processor, cause the processor to receive an input representative of a request to have a fifth voltage present at the location on the conductor.

20. The non-transitory computer-readable medium of claim 19, wherein the computer-executable instructions, when executed by the processor, cause the processor to determine an output voltage by the transformer to cause the location on the conductor to have the fifth voltage.
